(19) United States
(12) Patent Application Publication
(10) Pub. No.: US 2012/0069171 A1
(43) Pub. Date: Mar. 22, 2012

(54) IMAGING DEVICE FOR MICROSCOPE

(75) Inventors: Naoko KODAIRA, Tokyo (JP); Yasuhiro KOMIYA, Tokyo (JP)

(73) Assignee: OLYMPUS CORPORATION, Tokyo (JP)

(21) Appl. No.: 13/233,516

(22) Filed: Sep. 15, 2011

(30) Foreign Application Priority Data
Sep. 17, 2010 (JP) JP 2010-209720

(51) Int. Cl. H04N 7/18

(52) U.S. Cl. 348/79; 348/E07.085

(57) ABSTRACT

An imaging device including an imaging unit that obtains a video signal; a signal processing unit that processes the video signal; a movement detection unit that calculates a relative moving speed between the imaging unit and a stage in a first direction perpendicular to an optical axis of the imaging unit; a setting unit that determines a parameter such that time required for the signal processing is reduced where the relative moving speed is more than or equal to a threshold value; and, a frame rate conversion unit that selects between a process of increasing a frame rate of the video signal subjected to the signal processing where the relative moving speed is more than or equal to the threshold value, and a process of maintaining a current frame rate, to apply the selected process, wherein the signal processing unit applies the signal processing in accordance with the parameter.

### CROSS-REFERENCE TO RELATED APPLICATION

The present application claims priority based on Japanese Patent Application No. 2010-209720 filed on Sep. 17, 2010, all of which disclosure is incorporated herein by reference.

### TECHNICAL FIELD

The present invention relates to an imaging device for a microscope, which images a sample, applies signal processing and displays the sample on a monitor.

### RELATED ART

Recently, at the time of observing with a microscope, a digital camera has been used by mounting it to a conventional optical microscope to perform observation, imaging and operation on a monitor and the like. In particular, it is considered that this tendency will further increase, as the number of a so-called all-in-one model increases which does not have any eyepiece. In this system, signal processing is applied so that fine structures can be observed more clearly on the monitor.

However, a frame rate of images displayed on the monitor decreases as the amount of calculation in the signal processing increases to support observer's judgment. At the time of observation on the monitor, the decrease in the frame rate makes it difficult for a user to perform framing operations and focusing operations in a similar manner to the case where observation is performed with an eyepiece. In general, it is said that imaging operations such as the framing (positioning) operation and the focusing operation are difficult when the frame rate for display is 10 frames/second or lower.

In view of the problems described above, there is a known imaging device in which a user designates, in advance, signal processing parameters used at the time of display mode for observing motion pictures and at the time of imaging mode for imaging still pictures, and the signal processing parameters are switched, thereby securing visibility of images in the display mode used at the time of operations (see, for example, Patent Document 1).

### RELATED ART DOCUMENT

### Patent Document

Patent Document 1: Japanese Patent Application Laid-open No. 2006-287358

### DISCLOSURE OF THE INVENTION

### Means for Solving the Problem

An imaging device for a microscope according to the present invention provides an imaging device for a microscope that images a sample placed on a stage, applies signal processing, and displays the sample on a monitor, which includes: an imaging unit that images the sample to obtain a video signal; a signal processing unit that applies signal processing to the video signal obtained by the imaging unit; a movement detection unit that calculates a relative moving speed between the imaging unit and the stage in a first direction perpendicular to an optical axis of the imaging unit; a signal processing setting unit that determines a parameter such that, in the case where the relative moving speed in the first direction is more than or equal to a predetermined threshold value, time required for the signal processing performed by the signal processing unit is reduced as compared with the case where the relative moving speed is less than the predetermined threshold value; and, a frame rate conversion unit that selects between a process of, in the case where the relative moving speed in the first direction is more than or equal to the threshold value, increasing a frame rate of the video signal subjected to the signal processing by the signal processing unit as compared with the case where the relative moving speed is less than the threshold value, and a process of maintaining a current frame rate, thereby to apply the selected process, in which the signal processing unit applies the signal processing in accordance with the parameter determined by the signal processing setting unit.

In the imaging device for a microscope according to the present invention, the movement detection unit calculates the relative moving speed in the first direction on the basis of a relative motion vector between frames of the video signal obtained by the imaging unit.

In the imaging device for a microscope according to the present invention, the stage moves in the first direction using a first drive motor, and the movement detection unit calculates the relative moving speed of the sample in the first direction on the basis of a rotation amount of the first drive motor.

In the imaging device for a microscope according to the present invention, the signal processing unit has a noise-reduction processing unit, and the signal processing setting unit determines a parameter of the noise-reduction processing unit so as to, in the case where the relative moving speed in the first direction is more than or equal to a predetermined threshold value, reduce time required for noise reduction processing as compared with the case where the relative moving speed is less than the predetermined threshold value.

In the imaging device for a microscope according to the present invention, the movement detection unit further calculates a relative moving speed between the imaging device and the stage in a second direction parallel to the optical axis of the imaging unit; in the case where the relative moving speed in the first direction or the relative moving speed in the second direction is more than or equal to a predetermined threshold value, the signal processing setting unit determines a parameter so as to reduce time required for the signal processing performed by the signal processing unit, as compared with the relative moving speed is less than the predetermined threshold value; and, the frame rate conversion unit selects between a process of, in the case where the relative moving speed in the first direction or the relative moving speed in the second direction is more than or equal to the predetermined threshold value, increasing the frame rate of the video signal subjected to the signal processing by the signal processing unit, as compared with the case where the relative moving speed is less than the threshold value, and a process of maintaining a current frame rate, thereby applying the selected process.

In the imaging device for a microscope according to the present invention, the movement detection unit calculates the relative moving speed in the second direction on the basis of a blur amount change and/or brightness change between frames of the video signal obtained by the imaging unit.

In the imaging device for a microscope according to the present invention, the imaging unit moves in the second direction using a second drive motor, and, the movement detection unit calculates the relative moving speed of the sample in the second direction on the basis of a rotation amount of the second drive motor.

In the imaging device for a microscope according to the present invention, the signal processing unit has a noise-reduction processing unit, and the signal processing setting unit determines a parameter of the noise-reduction processing unit so as to, in the case where the relative moving speed in the second direction is more than or equal to a predetermined threshold value, reduce time required for noise reduction processing as compared with the case where the relative moving speed is less than the predetermined threshold value.

### BRIEF DESCRIPTION OF THE DRAWINGS

FIG. 1 is a block diagram schematically illustrating an imaging device for a microscope according to a first embodiment and a second embodiment of the present invention.

FIG. 2 is a configuration diagram of the imaging device for the microscope according to the first embodiment and the second embodiment of the present invention.

FIG. 3 is a block diagram of the imaging device for the microscope according to the first embodiment and the second embodiment of the present invention.

FIG. 4 is a block diagram of a noise-reduction processing unit of the imaging device for the microscope according to the first embodiment of the present invention.

FIG. 5 is a block diagram of a noise-reduction processing unit of the imaging device for the microscope according to the second embodiment of the present invention.

FIG. 6 is a block diagram schematically illustrating an imaging device for a microscope according to a third embodiment of the present invention.

FIG. 7 is a configuration diagram illustrating the imaging device for the microscope according to the third embodiment of the present invention.

FIG. 8 is a block diagram of the imaging device for the microscope according to the third embodiment of the present invention.

### BEST MODE FOR CARRYING OUT THE INVENTION

Hereinbelow, embodiments of an imaging device for a microscope according to the present invention will be described in detail with reference to the drawings.

### First Embodiment

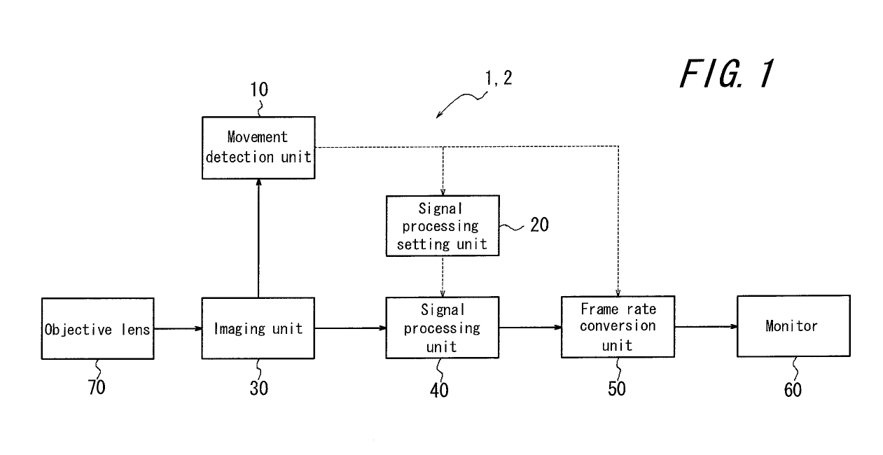

FIG. 1 is a block diagram schematically illustrating an imaging device for a microscope according to a first embodiment of the present invention. An imaging device 1 for a microscope includes a movement detection unit 10, a signal processing setting unit 20, an imaging unit 30, a signal processing unit 40, a frame rate conversion unit 50, a monitor 60 and an objective lens 70. In FIG. 1, the solid line represents a video signal and the dotted line represents a control signal.

The imaging unit 30 optically capture a video of an observation target formed by the objective lens 70, generates a video signal thereof, and outputs the video signal to the movement detection unit 10 and the signal processing unit 40.

The movement detection unit 10 detects movement (change) of “image” of the observation target in the video signal inputted from the imaging unit 30 to calculate a moving speed thereof, and, outputs information on the moving speed to the signal processing setting unit 20 and the frame rate conversion unit 50.

The signal processing setting unit 20 generates parameters for setting paths or properties of signal processing on the basis of the information on the moving speed inputted from the movement detection unit 10, and outputs the generated parameters to the signal processing unit 40.

The signal processing unit 40 applies signal processing to the video signal inputted from the imaging unit 30 in accordance with the parameters inputted from the signal processing setting unit 20, for example, so as to make the quality of the image lower or higher, and outputs the video signal to the frame rate conversion unit 50. For example, in the case where the moving speed is high (more than or equal to a predetermined threshold value), the parameter is determined such that time required for the signal processing by the signal processing unit 40 is shorter, as compared with a case where the moving speed is low (less than the predetermined threshold value).

The frame rate conversion unit 50 changes a frame rate of the video signal inputted from the signal processing unit 40 in accordance with the information on the moving speed inputted from the movement detection unit 10. For example, in the case where the monitor 60 can follow a high frame rate and the moving speed is high (more than or equal to a predetermined threshold value), the frame rate conversion unit 50 applies a process of increasing the frame rate of the video signal subjected to the signal processing by the signal processing unit 40, as compared with the case where the moving speed is low (less than the predetermined threshold value). Due to limitation of specifications of the monitor 60 in terms of the input frame rate, the frame rate conversion unit 50 can appropriately select, depending on the information on the moving speed, whether it converts the frame rate into the high frame rate, or it outputs the signal with a regular frame rate. For example, this selection is made by a CPU in a manner that accords with the specifications of the monitor 60 on the basis of the information set in advance. This improves smoothness of movement and flickering of the observation target in the case where the high frame rate is selected.

The monitor 60 displays the video signal whose frame rate is adjusted by the frame rate conversion unit 50, and is realized by an LCD, CRT or the like.

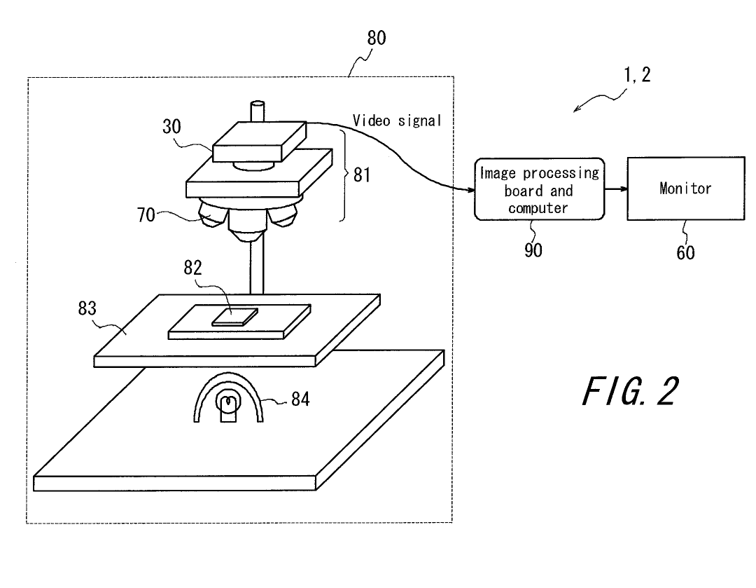

FIG. 2 is a configuration diagram in which the imaging device 1 for the microscope is applied to a microscope. A microscope 80 includes an imaging camera 81 having the imaging unit 30 and the objective lens 70, an X-Y stage 83 for mounting a sample 82, and a light source 84. An image processing board and computer 90 corresponds to the movement detection unit 10, the signal processing setting unit 20, the signal processing unit 40 and the frame rate conversion unit 50.

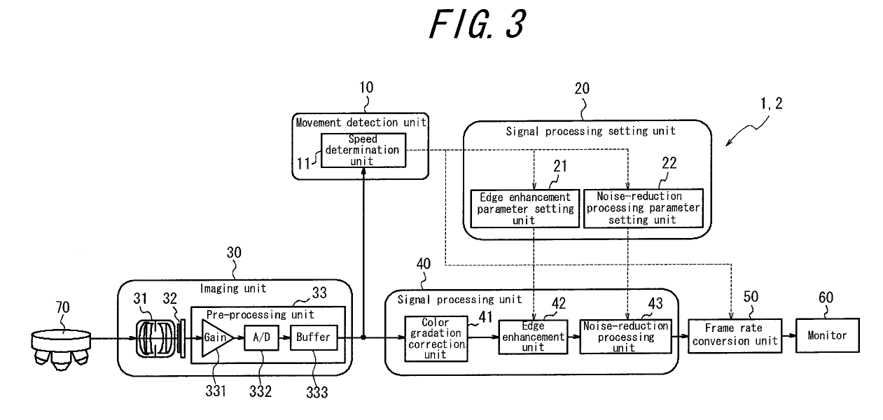

FIG. 3 is a block diagram of the imaging device 1 for the microscope, and illustrates the block diagram further in detail as compared with FIG. 1. In FIG. 3, the solid line represents the video signal, and the dotted line represents the control signal.

In the imaging device for the microscope according to this embodiment, an observer directly moves the sample 82 by his/her hand, or moves the sample 82 by manually adjusting the X-Y stage 83 with a horizontal position adjustment handle. The vertical position of the imaging camera 81 can be adjusted with a vertical position adjustment handle, whereby focusing operations can be made. The sample 82 is irradiated with an illuminating light emitted from the light source 84, and a transmitted light therethrough is inputted to the objective lens 70 as an observation light.

The movement detection unit 10 has a speed determination unit 11. The speed determination unit 11 calculates a relative moving speed between the imaging unit 30 and the X-Y stage 83 in a direction perpendicular to an optical axis of the imaging unit 30 (hereinafter, referred to as a horizontal direction). More specifically, in the case where the X-Y stage 83 moves in the horizontal direction, the speed determination unit 11 calculates the moving speed on the basis of change of video between frames of the video signal (relative motion vector) obtained from the imaging unit 30. For example, the speed determination unit 11 calculates a correlation value between a current frame and a previous frame to obtain the moving speed on the basis of the correlation value. The calculation of the correlation value includes calculation of the motion vector. Note that the same applies to a case where the imaging unit 30 moves in the horizontal direction.

Further, the speed determination unit 11 calculates a relative moving speed between the imaging unit 30 and the X-Y stage 83 in a direction parallel to the optical axis of the imaging unit 30 (hereinafter, referred to as a vertical direction). More specifically, in the case where the imaging unit 30 moves in the vertical direction, the speed determination unit 11 calculates the moving speed on the basis of a blur amount and/or brightness that change/changes according to the way in which focus is achieved. In this case, the speed determination unit 11 calculates a correlation value between the current frame and the previous frame in the video signal obtained from the imaging unit 30 to obtain the moving speed on the basis of the correlation value. Note that the same applies to a case where the X-Y stage 83 moves in the vertical direction.

The speed determination unit 11 outputs the calculated moving speed, or information concerning classification of the moving speed into a low speed, middle speed and high speed as information concerning the moving speed to the signal processing setting unit 20.

The signal processing setting unit 20 has an edge enhancement parameter setting unit 21, and a noise-reduction processing parameter setting unit 22. The edge enhancement parameter setting unit 21 generates a parameter for an edge enhancement process on the basis of the moving speed information inputted from the movement detection unit 10, and outputs the generated parameter to the signal processing unit 40. The noise-reduction processing parameter setting unit 22 generates a parameter for a noise-reduction process on the basis of the moving speed information inputted from the movement detection unit 10, and outputs the generated parameter to the signal processing unit 40.

In general, in the case where the stage or the imaging unit moves fast, it is not possible to timely follow the imaged images displayed on the monitor with a visual resolution property that humans have. Therefore, in the case where the moving speed is high, the signal processing setting unit 20 gives priority to the processing time to reduce the processing time required for the edge enhancement process or the noise-reduction process, while reducing the size of filter or generating a parameter for omitting a processing path, although the quality of the image is sacrificed. With this configuration, the frame rate does not decrease and it is possible to smoothly follow the movement of the sample 82, whereby the observer can smoothly perform the framing and the focusing operations.

On the other hand, in the case where the moving speed is low, the signal processing setting unit 20 gives priority to the reproduction of the image quality, and generates a parameter so as to sacrifice the processing time. In particular, in the case where the sample 82 is in a still state, the high frame rate is not necessary, and hence, the signal processing setting unit 20 lowers the frame rate, and increases the processing time sufficiently for resolution and reproduction, as well as for noise reduction.

It should be noted that it is preferable that, on the basis of the moving speed information from the movement detection unit 10, the signal processing setting unit 20 generates a parameter in a manner that properties change in a multistage manner or a smooth manner between the image obtained under the processing-time priority and the image obtained under the priority of the reproduction of the image quality.

Depending on application, the signal processing setting unit 20 may have a set of parameters in a table form, and generate parameters after interpolation, integration or other calculation.

The imaging unit 30 has an imaging optical system 31, an imaging element 32, and a pre-processing unit 33. A beam from the objective lens 70 is subjected to a focus adjustment and the like through the imaging optical system 31, and an image thereof is formed on the imaging element 32. The pre-processing unit 33 has a level adjustment gain 331, an A/D converter 332 and a buffer 333, converts a video signal captured by the imaging element 32 into a digital signal, and then outputs the digital signal to the movement detection unit 10 and the signal processing unit 40.

The signal processing unit 40 has a color gradation correction unit 41, an edge enhancement unit 42, and a noise-reduction processing unit 43. These units apply signal processing to the video signal obtained from the imaging unit 30, so that the observer of the microscope can perform monitor and observation with the image quality suitable for observation, and output the video signal to the frame rate conversion unit 50. Further, on the basis of the parameter from the signal processing setting unit 20, the processing paths or the signal properties change in a multistage manner between the processing speed priority and the image-quality reproduction priority.

The color gradation correction unit 41 applies a gradation correction process to the video signal inputted from the imaging unit 30, and outputs the video signal to the edge enhancement unit 42.

The edge enhancement unit 42 applies an edge enhancement process to the video signal inputted from the color gradation correction unit 41, and outputs the video signal to the noise-reduction processing unit 43. The edge enhancement process is performed on the basis of the parameter for the edge enhancement process inputted from the edge enhancement parameter setting unit 21.

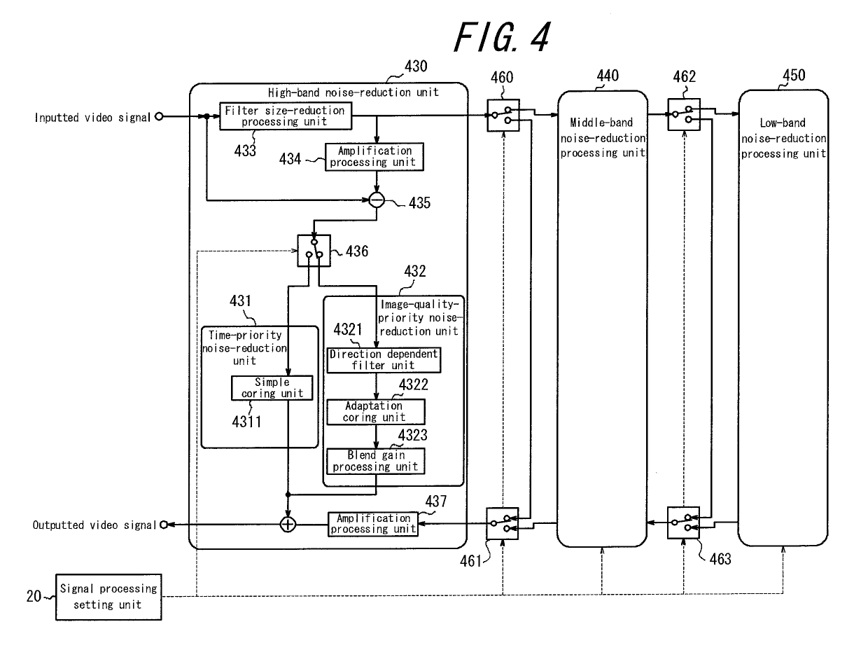

FIG. 4 is a block diagram illustrating a configuration example of the noise-reduction processing unit 43. The noise-reduction processing unit 43 has a high-band noise-reduction processing unit 430, a middle-band noise-reduction processing unit 440, a low-band noise-reduction processing unit 450, and path switches 460, 461, 462 and 463. This embodiment employs a multi-resolution filter that decomposes the inputted video signal from the signal with high frequency band into the signals with the low frequency band, and applies the noise-reduction process for each frequency band. Each of the high-band noise-reduction processing unit 430, the middle-band noise-reduction processing unit 440 and the low-band noise-reduction processing unit 450 has a filter size-reduction processing unit 433, amplification processing units 434 and 437, a subtracter 435, a selection switch 436, a time-priority noise reduction unit 431, and a image-quality-priority noise reduction unit 432. The configurations of the inside of each of the noise-reduction processing units are the same, and FIG. 4 only illustrates the configuration of the inside of the high-band noise-reduction processing unit 430.

The inputted signal is subjected to a filter process and a size-reduction process by the filter size-reduction processing unit 433, and is subjected to an amplification process by the amplification processing unit 434. The subtracter 435 performs subtraction to the inputted signal and the signal subjected to the amplification process by the amplification processing unit 434. The selection switch 436 outputs the signal subjected to the subtraction by the subtracter 435 to the time-priority noise-reduction unit 431 or the image-quality-priority noise-reduction unit 432, on the basis of the parameter inputted from the signal processing setting unit 20.

For example, the noise-reduction processing unit 43 performs the switch between the processing-time priority and the image-quality priority in a manner that sequentially switches processing of each band in accordance with the parameter from the signal processing setting unit 20. The high-band noise-reduction unit 430 switches between the time-priority noise-reduction unit 431 and the image-quality-priority noise-reduction unit 432 in accordance with the parameter inputted from the signal processing setting unit 20. In the case where the moving speed is low, the noise-reduction processing unit 43 selects the image-quality-priority noise-reduction unit 432 for all the bands including the high band, middle band and low band. In the case where the moving speed is middle, the noise-reduction processing unit 43 selects the image-quality-priority noise-reduction unit 432 for the high and the middle bands, and selects the time-priority noise-reduction unit 431 for the low band. In the case where the moving speed is high, the noise-reduction processing unit 43 selects the time-priority noise-reduction unit 431 for all the bands including the high band, middle band and low band.

The time-priority noise-reduction unit 431 has a simple coring unit 4311, and reduces the noise using the simple coring unit 4311.

The image-quality-priority noise-reduction unit 432 has a direction dependent filter unit 4321, an adaptation coring unit 4322 and a blend gain processing unit 4323. The direction dependent filter unit 4321 detects a directional component of an edge and the like in the image, and applies a filter process in the detected direction; the adaptation coring unit 4322 adaptively changes a coring threshold and reduces the noise; and, the blend gain processing unit 4323 adjusts the degree of noise reduction by determining a gain on the basis of the noise model that deals with brightness changes, and blending it with the band original signal immediately after the amplification processing unit 434.

It should be noted that details of the processes performed by the time-priority noise-reduction unit 431 and the image-quality-priority noise-reduction unit 432 are not limited to the processes illustrated in FIG. 4, provided that the time-priority noise-reduction unit 431 performs the processing so as to give higher priority to reduction in the processing time than the quality of images, and the image-quality-priority noise-reduction unit 432 performs the processing so as to give higher priority to improvement of the quality of images than the processing time. For example, it may be possible that the time-priority noise-reduction unit 431 and the image-quality-priority noise-reduction unit 432 employ direction dependent filters having filter sizes different from each other.

As another example of the switch between the processing-time priority and the image-quality priority, the noise-reduction processing unit 43 may switch the paths so as to omit the processing of a part of the bands in accordance with the parameter from the signal processing setting unit 20. For example, in the case where the moving speed is low, the noise-reduction processing unit 43 selects from among the path switches 460 to 462 such that the noise reduction processing is performed for all the bands including the high band, middle band and low band. In the case where the moving speed is middle, the noise-reduction processing unit 43 selects from among the path switches 460 to 462 such that the noise reduction processing is performed only for the high and middle bands, and is not performed for the low band. In the case where the moving speed is high, the noise-reduction processing unit 43 selects the path switches 460 to 462 such that the noise reduction processing is performed only for the high band, and is not performed for the middle and low bands.

It should be noted that it goes without saying that, in the noise-reduction processing unit 43, it may be possible to employ combination of the two examples described above, more specifically, it may be possible to combine the switch made for each band by the selection switch 436 between the time-priority noise-reduction unit 431 and the image-quality-priority noise-reduction unit 432, with the switch made by the path switches 460 to 462 as to whether processing is performed for each band. Further, the configuration of each of the signal processing setting unit 20 and the signal processing unit 40 described in this embodiment is only one example, and is not limited to this.

### Second Embodiment

Next, an imaging device for a microscope according to a second embodiment of the present invention will be described in detail with reference to the drawings. Note that the same reference numbers are denoted to the constituent elements same as those in the first embodiment, and explanation thereof will be omitted as appropriate.

An imaging device 2 for a microscope according to the second embodiment is the same as the imaging device 1 for a microscope according to the first embodiment, except for the configuration of the noise-reduction processing unit 43 of the signal processing unit 40. Therefore, the noise-reduction processing unit 43 of the imaging device 2 for the microscope will be described below. The noise-reduction processing unit 43 of the imaging device 2 for the microscope uses an inter-frame feedback filter. The inter-frame feedback filter reduces the nose by searching a portion having a high correlation between a previous frame that is stored in a memory and has been processed and a currently inputted frame, and blending them. Further, the inter-frame feedback filter may prepare plural frame memories and store several previous frames that have been processed to use them. The filter properties in a time direction can be set more in detail by increasing the number of the frames.

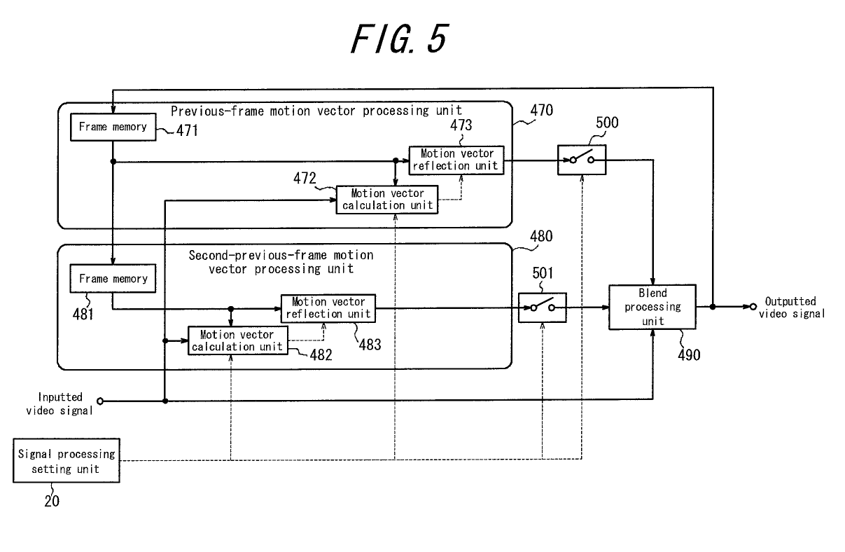

FIG. 5 is a block diagram of the noise-reduction processing unit 43 according to this embodiment. FIG. 5 illustrates a configuration of the noise-reduction processing unit 43 capable of storing two previous frames that have been processed, and blending three frames including a currently inputted frame. The noise-reduction processing unit 43 has a previous-frame motion vector processing unit 470, a second-previous-frame motion vector processing unit 480, a blend processing unit 490, and path memories 500, 501. The previous-frame motion vector processing unit 470 has a frame memory 471, a motion vector calculation unit 472, and a motion vector reflection unit 473. Similar to the previous-frame motion vector processing unit 470, the second-previous-frame motion vector processing unit 480 has a frame memory 481, a motion vector calculation unit 482, and a motion vector reflection unit 483.

The motion vector calculation unit 472 calculates a motion vector between a video signal of a currently inputted frame and a previous frame having been processed and stored in the frame memory 471 through block matching, and outputs it to the motion vector reflection unit 473. More specifically, the motion vector is calculated by cutting out the current frame into blocks having a certain size; calculating the degree of correlation with the previous frame within a predetermined searching area; and, specifying a relative position of blocks that are determined to have the highest correlation.

The motion vector reflection unit 473 generates a video signal in which the previous frame image stored in the frame memory 471 is moved, on the basis of a motion vector inputted from the motion vector calculation unit 472, and, outputs it to the blend processing unit 490.

The motion vector calculation unit 482 calculates a motion vector between a video signal of a currently inputted frame and a second previous frame having been processed and stored in the frame memory 481 through block matching, and outputs it to the motion vector reflection unit 483.

The motion vector reflection unit 483 generates a video signal in which the previous frame image stored in the frame memory 481 is moved, on the basis of a motion vector inputted from the motion vector calculation unit 482, and, outputs it to the blend processing unit 490.

The blend processing unit 490 blends (for example, averages) a video signal of the currently inputted frame, a video signal inputted from the previous-frame motion vector processing unit 470, and a video signal inputted from the second-previous-frame motion vector processing unit 480, and outputs the blended signal.

As for an example of switching between the processing-time priority and the image-quality priority, the noise-reduction processing unit 43 changes the searching range of the block matching and the sizes of the block in the motion vector calculation unit 472, 482 in accordance with the parameter inputted from the signal processing unit 20. In the case where the moving speed is low, the noise-reduction processing unit 43 performs its process in a wide searching range with a large block size. This makes it possible to generate the motion vector with high reliability and high accuracy although the processing time increases. On the other hand, in the case where the moving speed is high, the noise-reduction processing unit 43 performs its process in a narrow searching range with a small block size. This makes it possible to reduce the processing time although the quality of the image deteriorates along with reduction in reliability of the motion vector.

As for another example of switching between the processing time priority and the image-quality priority, the noise-reduction processing unit 43 may switch paths so as to omit a process or processes performed by the previous-frame motion vector processing unit 470 and/or the second-previous-frame motion vector processing unit 480 in accordance with the parameter from the signal processing setting unit 20. For example, in the case where the moving speed is low, the noise-reduction processing unit 43 makes the switches 500 and 501 closed to cause the previous-frame motion vector processing unit 470 and the second-previous-frame motion vector processing unit 480 to perform their own processes. In the case where the moving speed is high, the noise-reduction processing unit 43 makes the switches 500 and 501 open to omit the processes performed by the previous-frame motion vector processing unit 470 and the second-previous-frame motion vector processing unit 480.

As described above, according to the imaging device 1 for the microscope of the first embodiment and the imaging device 2 for the microscope of the second embodiment, it is possible to automatically switch, according to the moving speed of the sample 82, the signal processing between under the time priority and under image quality priority. This makes it possible to reduce the processing time in the case where the sample 82 moves in the horizontal direction, thereby improving the follow-up properties for the video and making framing operation easy. Further, for a video in a blur state during the time when the imaging element 32 or the objective lens 70 moves in the vertical direction and focus thereof is being adjusted, the reduced processing time improves the follow-up properties for the video, which makes the focus adjusting operation easy. Yet further, as the frame rate improves, the movement becomes smoother, and flickering can be reduced.

### Third Embodiment

Next, an imaging device for a microscope according to a third embodiment of the present invention will be described in detail with reference to the drawings. Note that the same reference numbers are denoted to the constituent elements same as those in the first embodiment, and explanation thereof will be omitted as appropriate.

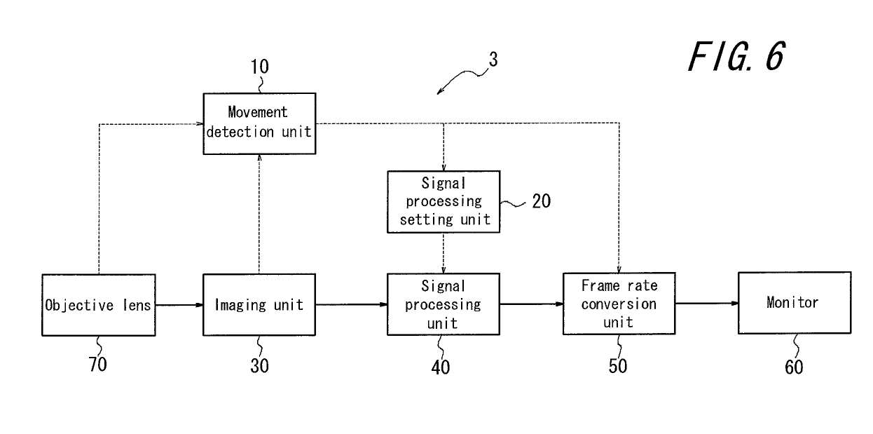

An imaging device 3 for a microscope according to this embodiment is different from the imaging device 1 for the microscope according to the first embodiment and the imaging device 2 for the microscope according to the second embodiment in that the imaging device 3 employs drive motors to move the X-Y stage 83 in the horizontal direction and move the imaging camera 81 in the vertical direction, and calculates the moving speed on the basis of a rotation amount of each of the drive motors. FIG. 6 is a block diagram schematically illustrating the imaging device for the microscope according to the third embodiment of the present invention. The movement detection unit 10 obtains setting information of the objective lens 70 and the imaging unit 30. In FIG. 6, the solid line represents the video signal and the dotted line represents the control signal.

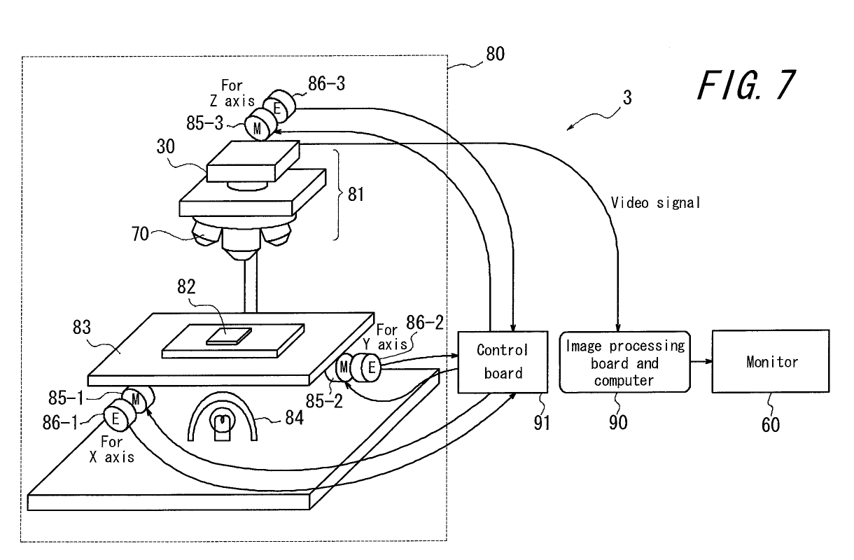

FIG. 7 is a configuration diagram illustrating a case where the imaging device 3 for the microscope is applied to a microscope. A microscope 80 includes an imaging camera 81 having the imaging unit 30 and the objective lens 70, the X-Y stage 83 for placing the sample 82, the light source 84, an x-axis drive motor 85-1, an x-axis encoder 86-1, a y-axis drive motor 85-2, a y-axis encoder 86-2, a z-axis drive motor 85-3, and a z-axis encoder 86-3.

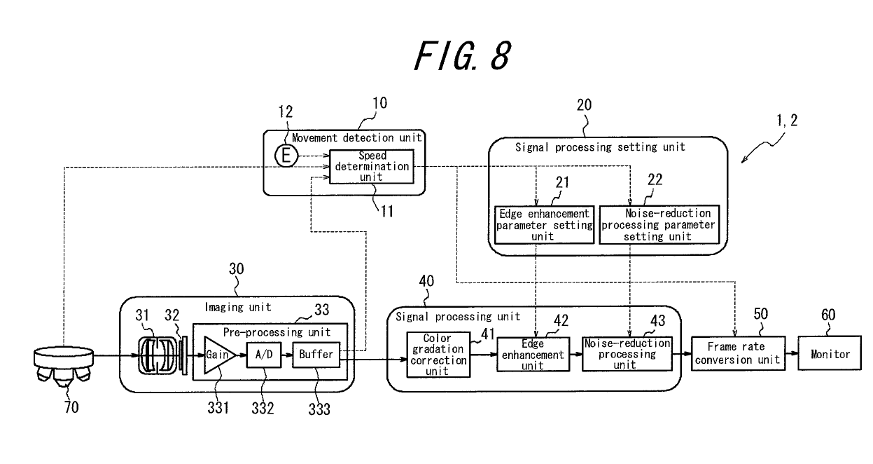

FIG. 8 is a block diagram illustrating the imaging device 3 for the microscope more in detail as compared with FIG. 6. In FIG. 8, the solid line represents the video signal, and the dotted line represents the control signal.

The movement detection unit 10 has the speed determination unit 11 and a movement detection sensor 12. The movement detection sensor 12 corresponds to the encoders 86-1 to 86-3 illustrated in FIG. 7. A control board 91 illustrated in FIG. 7 controls the x-axis drive motor 85-1 and the y-axis drive motor 85-2 to move the horizontal position of the X-Y stage 83 for placing the sample 82 to be observed in a sliding manner, and controls the z-axis drive motor 85-3 to move the imaging camera 81 in the vertical direction.

The encoders 86-1 to 86-3 (movement detection sensor 12) are attached to the drive motors 85-1 to 85-3, respectively, and detect the rotation amount of the drive motors 85-1 to 85-3 to output the detected rotation amount to the control board 91.

In the imaging device 1 for the microscope according to the first embodiment and the imaging device 2 for the microscope according to the second embodiment, the speed determination unit 11 calculates the moving speed on the basis of the video signal obtained from the imaging unit 30. On the other hand, in the imaging device 3 for the microscope according to the third embodiment, the moving speed is calculated on the basis of the rotation amount inputted from the control board 91 to generate moving speed information based on the calculated moving speed. Further, setting information of the objective lens 70 and setting information of the imaging unit 30 are taken into consideration in order to calculate the moving speed of the observation target displayed on the monitor 60.

More specifically, even if the moving speed of the X-Y stage 83 is the same, the moving speed of the observation target displayed on the monitor 60 is high in the case where the objective lens 70 is set at a high magnification or where the imaging view field of the imaging element is narrow. Therefore, the speed determination unit 11 generates the moving speed information not only on the basis of the output values from the encoders 86-1 to 86-3, but also by obtaining the setting information of the objective lens 70 and the setting information of the imaging unit 30.

As described above, according to the imaging device 3 for the microscope of the third embodiment, it is possible to automatically switch, according to the moving speed of the sample 82 on the monitor 60, the signal processing between under the time priority and under image quality priority even in the case where the X-Y stage 83 and the imaging camera 81 move by using the drive motors 85-1 to 85-3.

In the description above, the embodiments have been explained as typical examples. It is obvious for the skilled person in the art that various changes and replacements can be made within the gist and the scope of the present invention. Therefore, it should not be deemed that the embodiments described above limit the present invention. Further, it is possible to make various modifications and changes without departing from the scope of claims. For example, with the imaging device for the microscope according to the present invention, it may be possible to calculate the moving speed only in the horizontal direction in the case where inspection is performed to the observation target that moves in the horizontal direction on a line.

### EXPLANATION OF REFERENCE NUMERALS

1, 2, 3 Imaging device for microscope
10 Movement detection unit
11 Speed determination unit
12 Movement detection sensor
20 Signal processing setting unit
21 Edge enhancement parameter setting unit
22 Noise-reduction processing parameter setting unit
30 Imaging unit
31 Imaging optical system
32 Imaging element
33 Pre-processing unit
40 Signal processing unit
41 Color gradation correction unit
42 Edge enhancement unit
43 Noise-reduction processing unit
50 Frame rate conversion unit
60 Monitor
70 Objective lens
80 Microscope
81 Imaging camera
82 Sample
83 X-Y stage
84 Light source
85-1, 85-2, 85-3 Drive motor
86-1, 86-2, 86-3 Encoder
90 Image processing board and computer
91 Control board
331 Level adjustment gain
332 A/D converter
333 Buffer
431 Time-priority noise-reduction unit
432 Image-quality-priority noise-reduction unit
433 Filter size-reduction processing unit
434, 437 Amplification processing unit
435 Subtracter
436 Selection switch
461, 462, 463, 464, 500, 501 Path switch
470 Previous-frame motion vector processing unit
480 Second-previous-frame motion vector processing unit
490 Blend processing unit
4311 Simple coring unit
4321 Direction dependent filter unit
4322 Adaptation coring unit
4323 Blend gain processing unit

1. An imaging device for a microscope that images a sample placed on a stage, applies signal processing to the sample, and displays the sample on a monitor, comprising:
an imaging unit that images the sample to obtain a video signal;
a signal processing unit that applies signal processing to the video signal obtained by the imaging unit;
a movement detection unit that calculates a relative moving speed between the imaging unit and the stage in a first direction perpendicular to an optical axis of the imaging unit;
a signal processing setting unit that determines a parameter such that, in the case where the relative moving speed in the first direction is more than or equal to a predetermined threshold value, time required for the signal processing performed by the signal processing unit is reduced as compared with the case where the relative moving speed is less than the predetermined threshold value; and,
a frame rate conversion unit that selects between a process of, in the case where the relative moving speed in the first direction is more than or equal to the threshold value, increasing a frame rate of the video signal subjected to the signal processing by the signal processing unit as compared with the case where the relative moving speed is less than the threshold value, and a process of maintaining a current frame rate, thereby to apply the selected process, wherein
the signal processing unit applies the signal processing in accordance with the parameter determined by the signal processing setting unit.

2. The imaging device for a microscope according to claim 1, wherein
the movement detection unit calculates the relative moving speed in the first direction on the basis of a relative motion vector between frames of the video signal obtained by the imaging unit.

3. The imaging device for a microscope according to claim 1, wherein
the stage moves in the first direction using a first drive motor, and
the movement detection unit calculates the relative moving speed of the sample in the first direction on the basis of a rotation amount of the first drive motor.

4. The imaging device for a microscope according to claim 1, wherein
the signal processing unit has a noise-reduction processing unit, and
the signal processing setting unit determines a parameter of the noise-reduction processing unit so as to, in the case where the relative moving speed in the first direction is more than or equal to a predetermined threshold value, reduce time required for noise reduction processing as compared with the case where the relative moving speed is less than the predetermined threshold value.

5. The imaging device for a microscope according to claim 1, wherein:
the movement detection unit further calculates a relative moving speed between the imaging device and the stage in a second direction parallel to the optical axis of the imaging unit;
in the case where the relative moving speed in the first direction or the relative moving speed in the second direction is more than or equal to a predetermined threshold value, the signal processing setting unit determines a parameter so as to reduce time required for the signal processing performed by the signal processing unit, as compared with the relative moving speed is less than the predetermined threshold value; and,
the frame rate conversion unit selects between a process of, in the case where the relative moving speed in the first direction or the relative moving speed in the second direction is more than or equal to the predetermined threshold value, increasing the frame rate of the video signal subjected to the signal processing by the signal processing unit, as compared with the case where the relative moving speed is less than the threshold value, and a process of maintaining a current frame rate, thereby applying the selected process.

6. The imaging device for a microscope according to claim 5, wherein
the movement detection unit calculates the relative moving speed in the second direction on the basis of a blur amount change and/or brightness change between frames of the video signal obtained by the imaging unit.

7. The imagine device for a microscope according to claim 5, wherein
the imaging unit moves in the second direction using a second drive motor, and,
the movement detection unit calculates the relative moving speed of the sample in the second direction on the basis of a rotation amount of the second drive motor.

8. The imaging device for a microscope according to claim 5, wherein
the signal processing unit has a noise-reduction processing unit, and
the signal processing setting unit determines a parameter of the noise-reduction processing unit so as to, in the case where the relative moving speed in the second direction is more than or equal to a predetermined threshold value, reduce time required for noise reduction processing as compared with the case where the relative moving speed is less than the predetermined threshold value.
